(19) United States
(12) Patent Application Publication
(10) Pub. No.: US 2009/0172657 A1
(43) Pub. Date: Jul. 2, 2009

(54) System, Method, Apparatus, Mobile Terminal and Computer Program Product for Providing Secure Mixed-Language Components to a System Dynamically

(75) Inventors: Raine Makelainen, Tampere (FI); Juha Uola, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia, Inc.

(21) Appl. No.: 12/114,103

(22) Filed: May 2, 2008

Related U.S. Application Data
(60) Provisional application No. 61/017,259, filed on Dec. 28, 2007.

(51) Int. Cl. G06F 9/54; G06F 9/445

(52) U.S. Cl. 717/174; 719/328

(57) ABSTRACT

An apparatus for receiving secure-mixed language libraries for usage in a platform is provided. The apparatus includes a processing element that is configured to execute a platform which includes one or more packages containing one or more non-native applications and one or more libraries. The one or more libraries may consist of a native part and a non-native part. In this regard, the one or more libraries may contain software code associated with one or more different programming languages. One of the libraries of a package(s) consists of a native extension library. The processing element is configured to allow at least one of the non-native applications to call the libraries. The processing element is further configured to utilize the software code in the libraries to extend or add functions and/or functionality to at least one of the non-native applications.

### CROSS REFERENCE TO RELATED APPLICATIONS

This application claims the benefit of U.S. provisional patent application No. 61/017259, filed on Dec. 28, 2007, which is hereby incorporated by reference.

### TECHNOLOGICAL FIELD

Embodiments of the present invention relate generally to secure mixed language libraries, and more particularly, relate to a system, method, apparatus, and computer program product for providing mixed-language libraries that may be dynamically deployed to one or more platforms on devices.

### BACKGROUND

The modern communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, entertain themselves, etc. in either fixed or mobile environments. However, many electronic devices which have different operating systems may require different versions of a particular application to be developed in order to permit operation of the particular application at each different type of electronic device. If such different versions were developed to correspond to each different operating system, the cost of developing software and applications would be increased.

Accordingly, virtual machines (VMs) have been developed. A VM is a self-contained operating environment that behaves as if it is a separate computer. The VM may itself be a piece of computer software that isolates the application being used by the user from the host computer or operating system. For example, Java applets run in a Java VM that has no access to the host operating system. Because versions of the VM are written for various computer platforms, any application written for the VM can be operated on any of the platforms, instead of having to produce separate versions of the application for each computer and operating system. The application may then be run on a computer using, for example, an interpreter such as Java. Java, which is well known in the industry, is extremely portable, flexible and powerful with respect to allowing applications to, for example, access mobile phone features. Thus, Java has been widely used by developers to develop portable applications that can be run on a wide variety of electronic devices or computers without modification.

Many applications utilize libraries consisting of subprograms, code or data which provide services to the independent application program. These libraries may be static libraries or dynamic libraries. In this regard, static libraries such as native static libraries may consist of a set of routines which are copied into a target application by a compiler which may produce object files and a stand-alone executable file. As it relates to a non-native library such as a Java platform static library the corresponding libraries are not brought to the Java platform dynamically but rather are fixed on a device at the time of manufacture of the device or are pre-loaded on a memory of the device. In contrast, routines of a dynamic library may be loaded into an application program at runtime, rather than being linked at compile time and may remain as separate files. Dynamic libraries are a well-known mechanism in native runtime environments, such as in Windows and Linux. For instance, the Windows operating system uses Dynamic-link libraries (DLLs) and Linux utilizes shared objects (SOs) for loading components dynamically during runtime. Dynamic deployment of libraries is typically done using package managers, such as yum and apt on Linux.

Virtual runtime environments, such as in Sun Java or Microsoft (MS) .NET, which is the Microsoft Web services strategy to connect devices through software integrated across the Microsoft platform, provide more support for loading code dynamically. For example, Java provides ways to load code dynamically, even one class at a time, if a suitable class loader is provided. Still, Java archive (JAR) files that include a group of classes, are more commonly used as a deployment package. The MS .NET dynamic deployment mechanisms and composition capabilities heavily rely on so called assemblies. They represent an improvement over DLLs in that they contain additional metadata and a manifest file which specify further details of the assembly for example version number, vendor, etc.

Runtimes (also referred to herein as runtime engine) may consist of software that certain applications depend on to run or operate properly. The runtime typically must be running for a corresponding application to execute properly and it provides common routines and functions that the applications require. Additionally, runtimes may convert the application program, which may be in an interim, intermediate language, into machine language. In this regard, Java is an example of a runtime. Several dynamic deployment mechanisms exist for Java such as Jini and Java Management Extensions (JMX) being the most well-known. Jini is a set of application programming interfaces (APIs) and runtime conventions that facilitate the building and deploying of distributed Java systems. These frameworks may be tied to particular runtime (e.g., Java) and work solely inside the runtime.

Many mobile devices such as mobile phones utilize a Symbian operating system (OS) that is associated with libraries, user interface frameworks and reference implementations of common tools. Currently, on mobile platforms, the Symbian OS is also using DLLs. The Symbian installation (SIS) package format may be used to deploy native applications and libraries, but a dynamic deployment system is currently lacking. Many mobile Java platforms are based on the Mobile Information Device Profile (MIDP) platform, which enables deploying Java applications. In particular, the forthcoming Mobile Information Device Profile 3 (MIDP3) specification allows deploying of Java libraries (LIBlets) dynamically. Deploying of Java libraries dynamically provides a shared library concept for mobile Java applications. Applications and LIBlets can define dependencies to other LIBlets that can be deployed based on a provided uniform resource identifier, (URI) for example.

At present, static mixed-language applications are common both in the mobile and desktop world. Desktop Java platforms and advanced mobile Java platforms typically support Java Native Interface, (JNI) which is a defined way to integrate Java code and native code (e.g., programs specific to a hardware and/or operating system platform) such as for example C programming languages and/or C++ programming languages (C/C++). In this regard, the JNI is used to write native methods to handle situations when an application cannot be written entirely in the Java programming language such as when the standard Java class library does not support the platform-specific features or program library. JNI may also be used to modify an existing application, written in another programming language, to be accessible to Java applications. JNI allows building applications and libraries that allow Java code to call the native code as well as allow the native code to call Java code. Deploying an application with both Java and native code can be done on desktop with Sun Java Web Start technology.

One of the main problems with the Java runtime environment on desktop platforms, and especially on mobile platforms is the lack of access to native functionality. Java is based on standardized APIs, but this has the downside that access to wide native libraries is typically available only after standardization has been finished. For instance, the common way to standardize Java APIs to mobile devices is through a Java Community Process and often several years of collaboration between companies is needed before the API specification is finalized. As such, access to wide native libraries is available after standardization of the API(s) is completed. Often, Java APIs are more restricted than the native APIs, because a standard Java API needs to be implementable on various mobile platforms, including very low-end platforms. As a result, a standardized API often lacks access to the features that would be available on a high-end platform. In this regard, there is a need for Java application developers to have access to certain native functionality.

One other problem or drawback is that the Java platform is static and typically is not extended. Even though MIDP3 provides shared libraries, those libraries must include only Java code. This means that no new access to native libraries and/or applications can be opened with these libraries. Rather, it is possible only to build on top of the existing Java APIs. Also, the MIDP3 security model prevents Java libraries from defining Java native method declarations that may expose existing native functions.

Given the ubiquitous nature of mobile devices, currently mobile devices vary greatly in functionality and because of this variance many categories of devices have a different set of Java APIs. This is radically different from desktop devices (e.g., desktop computers) that are relatively homogeneous. In addition, on desktop devices each possible Java API can be part of the Java platform, because there is plenty of disk space available. In contrast, memory is a resource in mobile devices for which it is desirable to reduce consumption. To conserve memory space, it is desirable to provide only the minimum set of Java APIs on mobile devices, if additional APIs could be brought to the Java platform as needed.

In order to be able to extend a Java platform with new libraries that expose native functionality that has not been exposed earlier, a mixed-language library is typically needed. A mixed-language library may contain both native (e.g., C/C++) code and managed runtime (e.g., Java, Python, Flash, etc.) code. Deploying a mixed-language library is considerably a more complex problem than deploying a single-language library, because the security model for the mixed-language library should be able to cover both runtimes. Also, both native and managed runtime components (e.g., Java) need to be deployed so that their correct operation during runtime can be guaranteed. For example, it should be possible to call native functions from Java code using JNI.

The Symbian operating system used in mobile devices typically defines a security framework that includes an application/library package format, signing package with certificates and verifying the vendor on the device. However, the Symbian operating system security model is different from the one used in Java. Symbian installation packages may be used to deploy native Symbian applications and libraries to a device whereas a separate package format (e.g., JAR) is supported to allow deploying Java applications (and libraries with MIDP3). Currently, a mechanism does not exist to deploy a mixed-language library to a Symbian operating system so that it would be recognized by the managed runtime (Java). In this regard, when Java archive files are embedded into a SIS package, a native installer may treat them as data files as opposed to executable code or routines.

Given the above described problems, it may be advantageous to provide a mechanism for deploying secure mixed-language libraries to devices dynamically in order to support platforms generating native deployment packages so that the mixed-language libraries can be recognized by a managed runtime.

### BRIEF SUMMARY

The exemplary embodiments of the present allow deploying secure mixed-language libraries to a device dynamically by wrapping one or more libraries to a native (e.g., Symbian OS) deployment package such as an extension package. By using a native deployment package it is possible to use the existing security model of the operating system of the device without defining completely new package verification and/or handling mechanisms for mixed-language libraries. The origin of the mixed language libraries can be verified and the libraries can be trusted based on a signature or certificate within the native package. An existing native installer on a device may be utilized to perform the verification of the mixed-language libraries.

For instance, the native installer may install the files associated with the SIS package and the native installer need not be aware that it is installing one or more mixed language libraries (i.e., extensions). Additionally, the native installer may perform all the necessary security checks for the SIS package. The procedures needed to make the extension available to a runtime such as a Java runtime are performed by a platform extension mechanism device that is activated when the native installer has finished installing the extension. In this regard, the electronic device in which the extension is being installed can be sure that the integrity and origin of the extension has been checked by the native installer.

In one exemplary embodiment, a method for deploying secure mixed language libraries to a platform is provided. The method includes providing a platform which includes at least one package containing at least one first non-native application and one or more libraries. The one or more libraries contain computer instructions associated with a plurality of different programming languages. At least one of the libraries of the package includes a native extension library. The method further includes utilizing the first non-native application to call one or more of the computer instructions from at least one of the one or more libraries. The method also includes executing the one or more computer instructions in the one or more libraries which extends or adds one or more functions and/or functionality to the first non-native application.

In another exemplary embodiment an apparatus for deploying secure mixed language libraries to a platform is provided. The apparatus includes a processing element configured to provide a platform which includes at least one package containing at least one first non-native application and one or more libraries. The one or more libraries contain computer instructions associated with a plurality of different programming languages. At least one of the libraries of the package includes a native extension library. The processing element is further configured to utilize the first non-native application to call one or more of the computer instructions from at least one of the one or more libraries. Additionally, the processing element is further configured to execute the one or more computer instructions in the one or more libraries which extends or adds one or more functions and/or functionality to the first non-native application.

In another exemplary embodiment, a computer program product for deploying secure mixed language libraries to a platform is provided. The computer program produce includes at least one computer-readable storage medium having computer-readable program code portions stored therein. The computer readable code portions include first, second and third executable portions. The first executable portion is for providing a platform which includes at least one package containing at least one first non-native application and one or more libraries. The one or more libraries contain computer instructions associated with a plurality of different programming languages. At least one of the libraries of the package includes a native extension library. The second executable portion is for utilizing the first non-native application to call one or more of the computer instructions from at least one of the one or more libraries. Additionally, the third executable portion is for executing the one or more computer instructions in the one or more libraries which extends or adds one or more functions and/or functionality to the first non-native application.

In another exemplary embodiment an apparatus for deploying secure mixed language libraries to a platform is provided. The apparatus includes a means for providing a platform which includes at least one package containing at least one first non-native application and one or more libraries. The one or more libraries contain computer instructions associated with a plurality of different programming languages. At least one of the libraries of the package includes a native extension library. The apparatus further includes a means for utilizing the first non-native application to call the one or more of the computer instructions from at least one of the one or more libraries. Additionally, the apparatus includes a means for executing the one or more computer instructions in the one or more libraries which extends or adds one or more functions and/or functionality to the first non-native application.

Embodiments of the invention facilitate dynamic deployment of secure mixed-language libraries to mobile terminals and other electronic devices which may benefit from utilizing their existing security model to validate or verify packages which extend the functionalities of a platform such as a Java platform, for example.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an application according to an exemplary embodiment of the present invention; and

FIG. 4 illustrates a block diagram of a system for extending applications by using secure mixed-language libraries according to an exemplary embodiment of the present invention;

FIG. 5 is a schematic block diagram of a platform extension mechanism (PEM) device according to an exemplary embodiment of the present invention;

FIG. 6 is a diagram of a data model of an extension according to an exemplary embodiment of the present invention;

FIG. 7 illustrates an installation relating to an extension package according to an exemplary embodiment of the present invention; and

FIG. 8 is a flowchart according to an exemplary method of providing secure-mixed language libraries to a device dynamically according to an exemplary embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

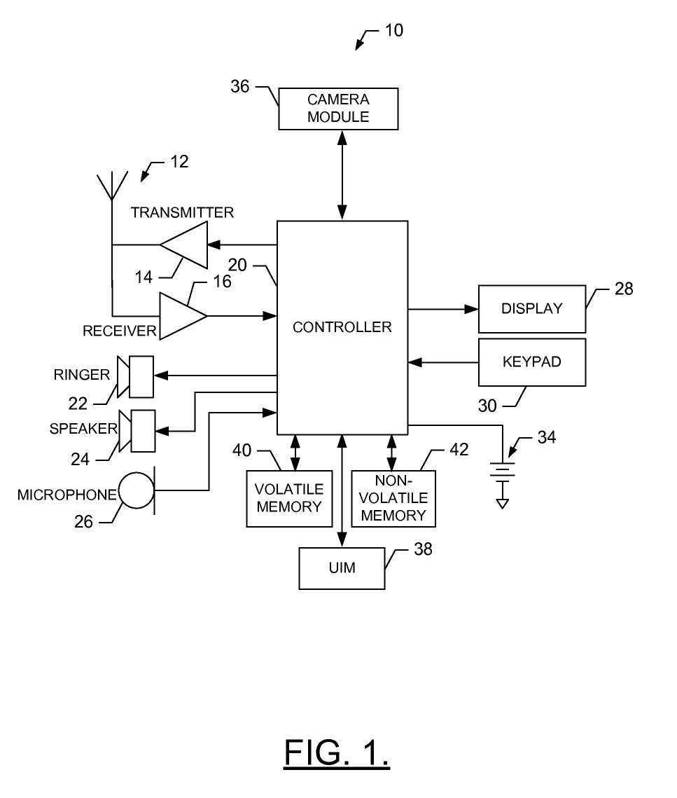

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA, with fourth-generation (4G) wireless communication protocols or the like.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), Hypertext Transfer Protocol (HTTP) and/or the like, for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing module 36, such as a camera, video and/or audio module, in communication with the controller 20. The media capturing module 36 may be any means for capturing an image, video and/or audio for storage, display or transmission. For example, in an exemplary embodiment in which the media capturing module 36 is a camera module, the camera module 36 may include a digital camera capable of forming a digital image file from a captured image. As such, the camera module 36 includes all hardware, such as a lens or other optical device, and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a universal identity element (UIM) 38. The UIM 38 is typically a memory device having a processor built in. The UIM 38 may include, for example, a subscriber identity element (SIM), a universal integrated circuit card (UICC), a universal subscriber identity element (USIM), a removable user identity element (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. In an exemplary embodiment, the memories 40 and 42 may store one or more mixed-language libraries which may contain both native code, for example C/C++ code and a managed runtime code including but not limited to a Java application, Flash application, Python application and/or the like. It should be pointed out that the mixed-language libraries may be pre-stored in the memories 40 and 42.

Although FIG. 1 illustrates an example of a mobile terminal which may utilize embodiments of the present invention, it should be understood that the mobile terminal 10 of FIG. 1 is merely an exemplary device that may utilize embodiments of the present invention. Generally speaking, any device having a processing element capable of employing an operating system for execution of applications or processes may utilize embodiments of the present invention. In this regard, for example, such a device may typically also include or otherwise be in communication with a memory device and may also include some form of user interface. A processing element such as those described above may also include some form of user interface. A processing element such as those described above may be embodied in many ways. For example, the processing element may be embodied as a processor, a coprocessor, a controller or various other processing means or devices including integrated circuits such as, for example, an application specific integrated circuit (ASIC).

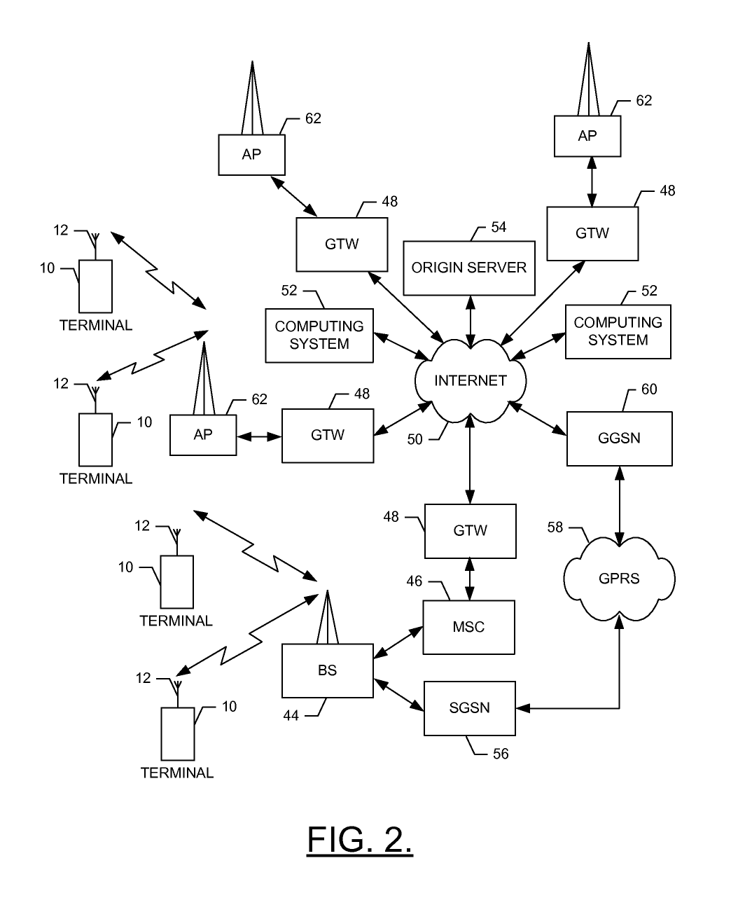

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention. In an exemplary embodiment, a network device such as for example origin server 54 and/or computing system 52 of the system of FIG. 2 may send one or more mixed-language libraries to a mobile terminal which may be similar to the mobile terminal 10 of FIG. 1.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

In an exemplary embodiment, data associated with a Java application or other application may be communicated over the system of FIG. 2 between a mobile terminal, which may be similar to the mobile terminal of FIG. 1 and a network device of the system of FIG. 2, or between mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on and executed solely at a communication device such as the mobile terminal 10, or may be resident on and executed at a network device or other device.

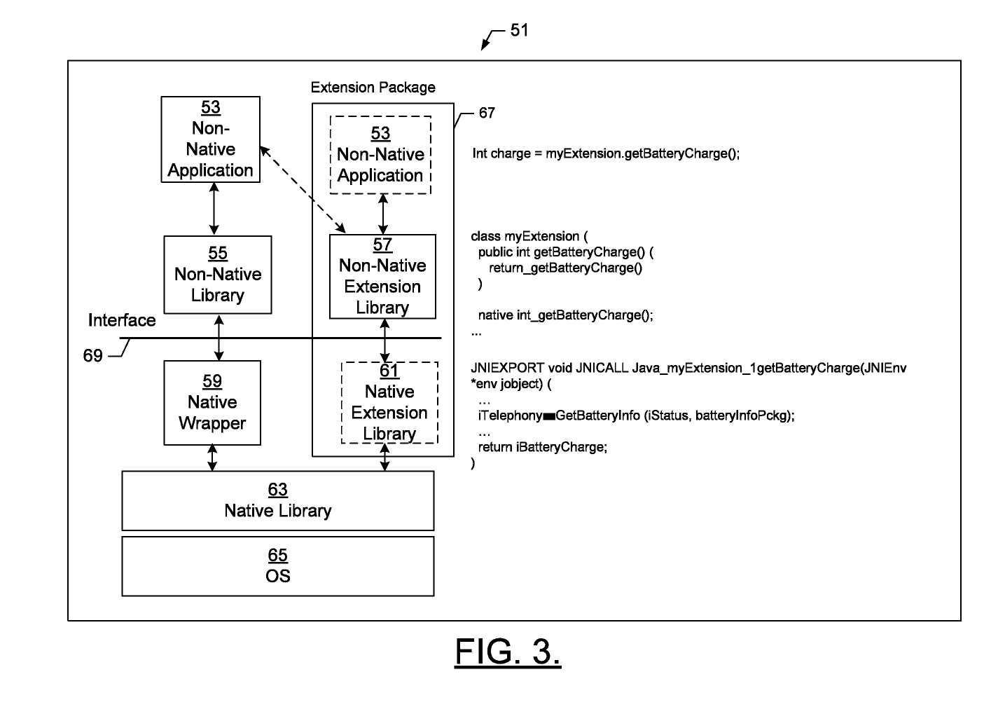

Referring now to FIG. 3, an exemplary embodiment of an application which includes an extension package as well as other data is provided. In an alternative exemplary embodiment, the extension package 67 may be a Symbian Installation Package. The runtime platform 51 may be stored in a memory on a mobile terminal such as mobile terminal 10. While one runtime platform 51 is shown in FIG. 3 it should be pointed out that the mobile terminal may store any suitable number of runtime platforms 51. The mobile terminal may utilize an operating system such as, for example, a Symbian OS which has associated libraries, user interface frameworks and reference implementations of common tools. The runtime platform 51 may be a Java platform, Flash platform, Python, Microsoft .NET platform or any other suitable platform. However, for purposes of illustration and not of limitation, the runtime platform 51 will be described primarily with respect to a Java platform. It should be pointed out that the runtime platform 51 may be executed by a processor, controller or the like such as controller 20. The runtime platform 51 may include one or more non-native applications 53. The non-native applications 53 may consist of any suitable application(s) and may include but are not limited to applets, Xlets, (e.g., Java application supporting a digital television receiver) and one or more mobile information device profile applications (MIDlets) which are applications (e.g., Java applications) for mobile devices written for a Java platform, which conforms to a Mobile Information Device Profile (MIDP) (or MIDP3) that consists of a set of Java 2 Platform Micro Edition (J2ME) APIs that define the manner in which software applications interface with mobile electronic devices.

As shown in FIG. 3, an optional non-native application 53 (e.g., MIDlet) may be included in the extension package 67 of the runtime platform 51 which includes or consists of code or an instruction such as “int charge=myExtension.getBatteryCharge( );”. Additionally, the extension package 67 may contain one or more mixed-language libraries (also referred to herein as extensions). In particular, the extension package 67 may contain a non-native extension library 57 such as for example a Java extension library, which may consist of a set of code, data, instructions, software routines, subprograms, etc. that are utilized by a particular application program, such as for example a Java application. In this regard, the non-native extension library 57 consists of code, data, instructions routines, subroutines (also referred to herein collectively as code) and the like that may correspond to an interpreted application such as, for example, a Java application that is not native to a single platform. In other words, the non-native extension library 57 may consist of code that corresponds to an application that can run independently of a particular computer architecture or operating system (e.g., Windows operating system). It should be pointed out that the non-native extension library 57 is capable of extending or adding functionality or services to a non-native application or program, such as for example, a Java application. The non-native extension library 57 is capable of receiving the “int charge=myExtension.getBatteryCharge( );” code from a respective one of the non-native applications 53 and is also capable of storing code including but not limited to “class myextension (public int getBatteryCharge( ) (return_getBatteryCharge( )) native int_getBatteryCharge( ); . . . ”. It should be pointed out that the non-native extension library 57 may provide additional services or functions to one or more Java applications stored on the mobile terminal 10.

The extension package 67 may also include a native extension library 61 which includes but is not limited to a collection of programs, software routines, code, instructions, data or the like (also referred to herein collectively as code) for an application that is designed to run in the environment of the operating system, such as for example a Symbian OS which may utilize C and/or C++ program code, for example. The code stored in the native extension library 61 may be utilized to extend or add functionality or services to native applications such as for example applications utilizing the C/C++ program language of an operating system of the mobile terminal. An example of the code that may be stored in the native extension library 61 consists of “JNIEXPORT void JNICALL Java_myExtension_igetBatteryCharge(JNIEnv*env, jobject) ( . . . itelephony→GetBatteryInfo (iStatus, batteryInfoPckg); . . . return iBatteryCharge;)” as shown in FIG. 3. As can be seen in FIG. 3, the non-native code of the non-native extension library 57 as well as the native code of the native extension library 61 may be communicated or exchanged between the two libraries 57 and 61 by utilizing an interface 69 such as for example, a Java Native Interface (JNI), which is a programming interface that allows Java code to call and be called by native applications (e.g., applications written in C/C++) and libraries written in languages other than Java. In this regard, the interface 69 (e.g., JNI) allows non-native applications such as Java applications to be able to utilize native applications, such as for example code from the non-native library 61 that is specific to a particular program (e.g., C/C++) or platform (e.g., operating system). Similarly, the interface 69 (e.g., JNI) enables native applications (e.g., C/C++) to be able to utilize non-native applications such as for example Java code in the non-native extension library 57.

Additionally, the code of the native extension library 61 may be provided to the native library 63 of the runtime platform 51. The native library 63 may include routines, subroutines, software code, data and/or the like (also referred to herein interchangeably as code) which are in a programming language, or which conform to the operating system, of a particular device such as mobile terminal 10. In an exemplary embodiment, the native library 63 may consist of code that conforms to the C/C++ programming languages that is utilized by a Symbian operating system. However, the native library 63 may consist of other suitable codes corresponding to other programming languages (e.g., Microsoft .NET) and operating systems including but not limited to Microsoft Windows operating system, Linux, Unix, DOS, etc. The operating system (OS) data 65 may contain programs, software code, data and/or the like for the operating system which may be utilized to manage the sharing of the resources (e.g., code in the libraries 55, 57 and 61 of the runtime platform 51) on a device such as mobile terminal 10.

Additionally, within runtime platform 51 a respective one of the non-native applications 53 may consist of an application such as a MIDlet (e.g., Java applications) for mobile devices which may be written with a platform such as a Java platform for example, as discussed above and the non-native application 53 may provide data associated with its application to the non-native library 55 and optionally the non-native extension library 57 as shown in FIG. 3. The non-native library 55 may consist of one or more subroutines, software code, macros, data and/or the like conforming to a non-native application. In an exemplary embodiment, the non-native library may consist of one or more subroutines, software code, macros, data and/or the like corresponding to Java applications that may be called by the Java application(s) at runtime, for example. It should be pointed out that at least some of the non-native library code may be provided to the corresponding non-native application 53. Additionally at least some of the non-native library code may be communicated to the native wrapper 59 via interface 69, in a manner analogous to that discussed above. The native wrapper 59 may consist of software which adapts or transforms a code of a particular type of application or the like (e.g., non-native applications such as Java applications) into the format of another type of application (e.g., native applications such as C/C++ application(s)). The native wrapper 59 is capable of providing the code that was transformed from the non-native application (e.g., Java application) to the native application(s) (e.g., C/C++ applications(s)) to the native library 63. In this regard, the native library 63 may provide the code transformed or adapted by the native wrapper 59 to a corresponding native application (e.g., C/C++ application(s)) when transformed code is required or requested by the native application.

By utilizing the extension package 67 of the runtime platform 51, the mobile terminal is capable of bringing extension packages consisting of multiple language libraries to the platform (e.g., operating system) of the mobile terminal 10. In an exemplary embodiment, the extension package 67 may consist of one or more logical components conforming to a Java Specification Request (JSR) implementation. In an alternative exemplary embodiment, the extension package 67 may include another application or an additional Java library that may utilize the additional services and functions provided by the extension. Additionally, it should be pointed out that a pure Java extension without any native extension library may be included in the extension package 67.

Additionally, it should be pointed out that an extension package can be pre-loaded in a memory of the mobile terminal 10. As referred to herein extension packages 67 that are pre-loaded in memory may be referred to as static extensions. Moreover, an extension package 67 may be dynamically installed in a memory of an electronic device such as mobile terminal 10. For example, the extension package may be generated by a device such as origin server 54 or computing systems 52, which may dynamically send the extension package 67 to the mobile terminal 10. As referred to herein extension packages 67 that are dynamically installed in a memory of an electronic device such as mobile terminal 10 may be referred to as dynamic extensions.

The extension package may include one or more mixed-language libraries. For instance, the extension package may include a runtime extension library and a native extension library. The runtime extension library may consist of a Java, Flash, Python, library or the like. The native extension library may include code, data, subroutines, etc. which correspond to a programming language such as C and/or C++ for example.

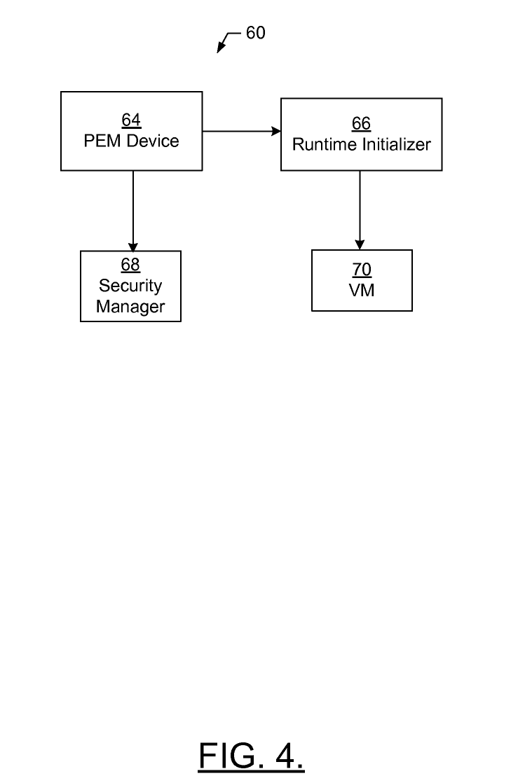

Referring now to FIG. 4, an exemplary embodiment of the invention will now be described with reference to FIG. 4, in which certain elements of a system 60 (also referred to herein as a Platform Extension Mechanism (PEM) system) for extending applications by providing secure mixed-language libraries to a device dynamically are displayed. In particular, the system 60 is capable of facilitating a platform (e.g., Java platform) to be extended by utilizing one or more mixed-language libraries within the system. In this regard, the system 60 fosters deployment of mixed-language libraries (i.e., extensions) to a non-native platform (e.g., Java platform) and facilities patching the existing platform. Once the extensions are installed within the platform of a device such as mobile terminal 10, the extensions may remain on the platform until uninstalled.

Extensions can be used to implement full-fledged Java APIs on a device such as mobile terminal 10. The Mobile Information Device Profile 3 (MIDP3) standard allows Java applications to define dependencies to standard APIs, which makes it possible to deploy extensions to a device (e.g., mobile terminal 10) as needed. In this regard, the system 60 allows defining dependencies between extensions, so that necessary sets of extensions can be downloaded to the mobile terminal 10 from the origin server 54 or the computing systems, for example.

By using system 60, it is also possible to tie an extension to a particular application vendor that provides an application that is packaged together with the extension (referred to hereinafter as a coupled application) The extension(s) may then be available only for that application. Such an extension can also be used to expose sensitive native APIs. For example, it is possible to provide an extension that provides an API for accessing user personal data on a device. An application from a particular vendor packaged together with the extension is able to use this API, but it is not available for other (e.g., untrusted) applications. Other applications are limited to the standard Java APIs available on the device. Coupled applications can be restricted to a device manufacturer and/or operator.

The system 60 includes a platform extension mechanism (PEM) device 64, a runtime initializer 66, a security manager 68 and a virtual machine (VM) 70. It should be pointed out that a processor or controller such as controller 20 of mobile terminal 10 may execute the functions of the PEM device 64, runtime initializer 66, security manager 68 and VM 70 that are described more fully below. The system illustrated in FIG. 4 may be resident on, and operate within for example mobile terminal 10 of FIG. 1. However, embodiments of the present invention are not to be limited merely to application in mobile terminals. As stated above, although embodiments of the invention can be advantageously employed on mobile terminals, embodiments may also be employed in electronic devices as well. In an exemplary embodiment, the mobile terminal 10 may be utilizing an operating system including but not limited to a Symbian operating system, Windows operating system, Linux, Unix, DOS operating system or the like.

The PEM device 64 may be any device in hardware and/or software or a combination of hardware and software that is capable of managing extensions, managing meta-data of each installed extension, identifying and verifying extensions, and providing the necessary start-up parameters to the runtime initializer 66.

The security manager 68 may also be embodied by hardware and/or software and, in one embodiment, is embodied in software as instructions that are stored on a memory of the mobile terminal 10 which may be executed by a processing element, such as controller 20. In one embodiment, the security manager 68 may be embodied by any device or means in hardware and/or software or a combination of hardware and software that is configured to handle security policies and grant applications access to sensitive Java methods based on permissions during the execution of a program or application i.e., at runtime. It should be pointed out that each sensitive Java method includes a permission check point that is checked by the security manager. The security manager checks the permission of the application before execution continues from the Java method to a native side application, via interface 69 (e.g., JNI). Sensitive Java methods are specified in the standardized Java API specifications. It should be pointed out that the security manager 68 may be active during installation of a corresponding application when application permission dependencies are checked by the operating system, for example. The runtime initializer (RI) 66 (e.g., Java runtime initializer) may also be embodied by hardware and/or software and, in one embodiment, is embodied in software as instructions that are stored on a memory of the mobile terminal 10 which may be executed by a processing element, such as controller 20. In this regard, the RI 66 may be embodied by any device in hardware/and or software or a combination of hardware and/or software that is configured to initialize a runtime process (e.g., a Java runtime process) with the parameters that are provided to it by the PEM device 64. In an exemplary embodiment, the runtime initializer 66 may be embodied within the PEM device 64. The virtual machine (VM) 70 (e.g., Java VM) may be any device in hardware and/or software that is configured to execute a program or application (e.g., Java programs or Java applications) based on the parameters it receives from the runtime initializer 66. In an exemplary embodiment, the VM 70 is embodied in software as instructions that are stored on a memory of the mobile terminal 10 which may be executed by a processor such as controller 20.

It should be pointed out that the mobile terminal may utilize a platform such as for example a Java platform consisting of one or more programs which allow running and execution of programs written in the Java programming language. The Java platform may be stored in a memory of the mobile terminal 10. The Java platform is not specific to any one processor or operating system, but rather the VM 70 which facilities execution of Java programs and applications. In an exemplary embodiment, the Java platform may also consist of an interpreter with a set of standard libraries which are implemented for various hardware and operating systems so that Java programs can run identically on all of them.

During the execution of an application (application 53) or program (i.e., a runtime) such as for example a Java program, the runtime initializer (RI) 66 (e.g., Java Runtime Initializer (JRI)) is notified and it starts the VM 70 and instructs the VM to start executing the particular application such as for example application 53. It should be pointed out that execution of the program (e.g., Java program) may occur when a user activates an application icon (e.g., Java application icon) or according to any other suitable mechanism. The RI 66 passes parameters to the VM. These parameters may consist of a non-native library and/or non-native extension library names. In contrast, native libraries may be automatically found from a particular directory such as for example /sys/bin on the Symbian OS. The parameters that the RI 66 passes to VM include but are not limited to (1) parameters associated with a path to an application library (e.g., a non-native library that is brought inside the non-native application 53 which may be a Java library), from where all the application classes are loaded by the VM 70; and (2) parameters associated with a path to one or more system class libraries (e.g., Java library 55), from where all the platform classes are loaded by the VM 70. The VM 70 may then execute the application such as non-native application 53 for example that may be using one or more codes from one or more system class libraries. It should be pointed out that non-native library 57 (e.g., Java library) may include a call to load a native library 61. In this regard, the interface 69 (e.g., JNI) may load the native library 61 into the non-extension library 57 by calling a dynamically linked library such as a System.loadLibrary (i.e., “IMEIExtension.dll”). The VM 70 is then able to load a library with the IMEIExtension.dll name from a particular directory such as for example a directory named /sys/bin on the Symbian operation system.

The system classes, for example codes of the Java library, may consist of one or more calls to the security manager 68 whenever a security sensitive method or function (e.g., a Java method which may be a Java technology-specific protocol for looking up and referencing remote objects) is about to be executed. For example, a security sensitive method may allow accessing user private data, such as private documents, on the device (i.e., mobile terminal). The security manager 68 then checks whether the application (i.e., application 53) has the appropriate rights to execute that method. In an exemplary embodiment, the security manager may evaluate data associated with an identifier to determine whether the application has a right to execute the method or function specified by the code. If not, the operation is denied by the security manager 68 or the user of the mobile terminal is asked for confirmation that the method or function is to be executed. The user may authorize or confirm the right to execute the method or function by using the keypad 30 or user input interface of the mobile terminal 10 or according to any other suitable manner. The security manager 68 utilizes a profile that exists in the system 60 and which may be stored in mobile terminal 10 to perform the security check. For example, the security manager 68 may compare an identifier stored in the profile that is associated with approved vendors of applications with data (e.g., an identifier (ID)) within the corresponding code that identifies the vendor of the code. If the identifier stored in the profile does not match the identifier of or within the code, the security manager 68 may deny the operation associated with the code, in the manner discussed above.

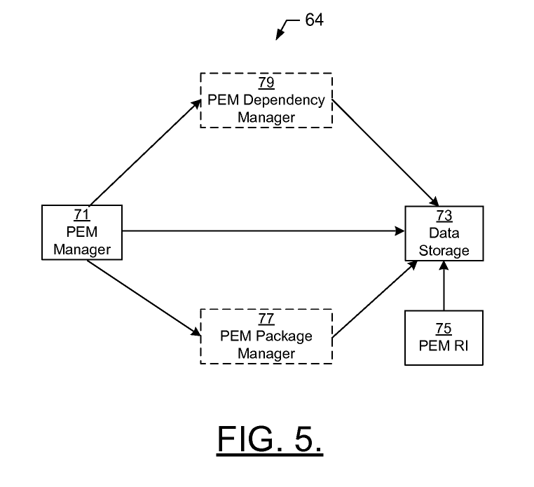

Referring now to FIG. 5, components of the PEM device 64 are shown. In particular, the PEM device 64 includes a PEM manager 71, a data storage device 73, a PEM runtime initializer 75 and optionally includes a PEM package manager 77 and a PEM dependency manager 79. Of these the PEM manager 71, the PEM runtime initializer 75, the PEM package manager 77 and the PEM dependency manager 79 may be embodied by hardware and/or software and, in one embodiment, are embodied in software as instructions that are stored on a memory of the mobile terminal 10 which may be executed by a processing element, such as controller 20. In this regard, the PEM manager 79 may be any device in hardware and/or software or a combination of hardware or software that is capable of identifying and verifying one or more extensions, obtaining extension meta-data and storing the meta-data in data storage device 73. The PEM manager 79 may be active during installation of an extension, update of an extension as well as uninstallation of an extension. In this regard, the PEM manager 79 is capable of identifying one or more extension parts (within the extension package 67) such as for example: (1) non-native application 53 (e.g., a MIDlet); (2) non-native extension library 57 (e.g., Java extension library); and (3) a native extension part such as native extension library 61. The PEM manager 79 is also capable of providing the non-native data i.e., code of the non-native part of the extension package to a non-native platform (e.g., Java platform) and is also capable of providing the native part, i.e., code of the extension package to a native application (e.g., programming language such C/C++) or native platform (e.g., operating system such as Symbian).

The data storage device 73 may be a memory device such as non-volatile memory (e.g., flash memory or alternatively volatile memory such as for example a random access memory (RAM), etc. As noted above, the data storage device 73 is capable of storing meta-data for each extension that is installed to the mobile terminal 10. The data storage device may be updated during installation of an extension, update of an extension and uninstallation of an extension. Additionally, the data storage device 73 may be read by the PEM dependency manager 79, the PEM package manager and PEM runtime initializer 75 when an application such as, for example, a Java application is started.

The PEM runtime initializer 75 (e.g., a Java PEM runtime initializer) may be any device in hardware and/or software or a combination of hardware and software capable of fetching the necessary start-up parameters from data storage device 73 and provide the start up parameters to the VM 70 via the runtime initializer 66. (See FIG. 5) The PEM runtime initializer 75 may be active when an application such as a Java application is started.

The PEM package manager 77, which may be optionally included in the PEM device 64, may be any device in hardware and/or software or a combination of hardware and software that is capable of managing packages such as for example Java packages. The PEM package manager 77 ensures that non-native extension libraries include packages from namespaces that match the vendor that is providing the extension libraries. This is a well-known convention in the Java language and the PEM package manager 77 enforces this convention. For example, consider classes in Java package “com.acme” that originate from a company called Acme. The PEM package manager 77 is able to identify the originator of the Java package from the namespace “com.acme” which allows corresponding applications to trust that certain Java packages come from certain vendors and not from unknown origins. The PEM dependency manager 79 which may optionally be included in the PEM device 64 may be any device in hardware and/or software or a combination of hardware and software capable of managing dependencies between one or more extensions and one or more platforms.

As discussed above, in the current or existing systems Java platform libraries are typically static. However, utilizing the exemplary embodiments of the present invention, allows a user of a mobile terminal to install and uninstall extension libraries freely in non-native platforms such as a Java platform. Given that the user may install extension libraries freely, the PEM dependency manager 79 is capable of determining whether one or more libraries (e.g., a set of libraries) that the user installed will be working as expected. The PEM dependency manager 79 may be active during installation of an extension, during update of an extension, or uninstallation of an extension. The PEM dependency manager 79 is capable of receiving extension meta-data from the PEM manager installation, update or uninstallation of a corresponding extension. In this regard, the PEM dependency manager 79 may utilize the meta-data associated with the corresponding extension to manage dependencies (e.g., software, program, code or the like that is not shared between applications and not specific to one application) between extension instances and platform non-native and native libraries (e.g., non-native library 55, native wrapper 59). For example, an extension named A may depend on an extension named B. Furthermore, an extension A may depend on a platform API C that is implemented by a non-native library D (e.g., non-native library 55). Furthermore, an extension A may depend on a particular native library E (e.g., native library 63) or even an operating system F (e.g., OS 65).

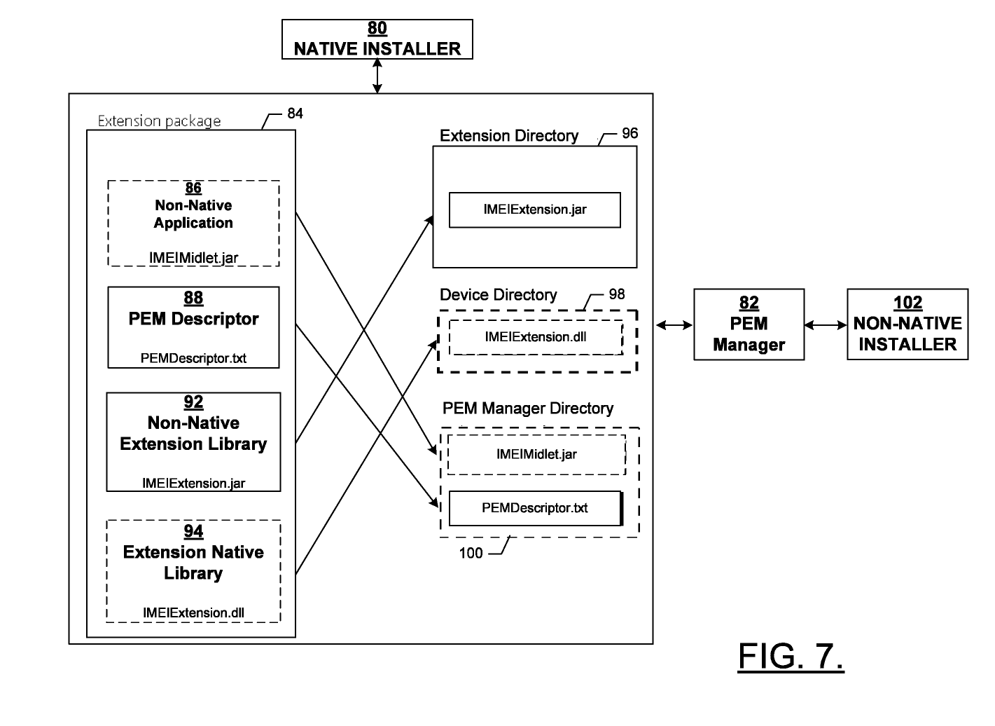

The extensions of the exemplary embodiments of the present invention may define their dependencies in an extension descriptor that includes meta-data associated with the extension (such as for example the “PEMDescriptor.txt” shown in elements 88 and 100 of FIG. 7). The PEM dependency manager may check the dependencies associated with an extension and if the dependencies are found on the mobile terminal for example, the corresponding extension may be installed. On the other hand, if the dependency is not found on the mobile terminal, the corresponding extension may not be installed. In an alternative exemplary embodiment, even if the PEM dependency manager 79 does not find the dependency, the mobile terminal may offer an option to the user to install the required extensions anyway. The user may select this option using keypad 30 or the user input interface of the mobile terminal.

As an example of the manner of operation of the dependency manager 79 consider a Static Java platform which implements features A and B, an extension denoted as Extension 1 which depends on feature A and an extension denoted as Extension 2 as well as a feature C where Extension 2 depends on features A and B and implements feature C. During the installation of Extension 1 for example, the PEM dependency manager 79 may determine that that the dependency to Extension 2 is not satisfied (e.g., not found on the mobile terminal), which provides a prompt to the user indicating a denial of installation of the corresponding extension. However, as noted above, in an alternative exemplary embodiment, the PEM dependency manager 79 offers the user an opportunity, via a prompt, to install Extension 2 or it may even find and install Extension 2 automatically by retrieving it from origin server 54 or computing systems 52, for example, and may proceed with installing Extension 1. In this regard, the corresponding platform remains functional. In situations in which the PEM dependency manager 79 is not included in the PEM device 64, the mobile terminal may be able to install Extension 1, but since Extension 2 is not present on the mobile terminal, the mobile terminal may not be able to install Extension 2. In this regard, when an application (e.g., Java application) that uses Extension 1 is initialized or activated a runtime error results due to lack of Extension 2. As such, if the PEM dependency manager 79 is implemented in PEM device 64, it may improve the robustness of the corresponding platform by minimizing the runtime errors that a mobile terminal may encounter. The PEM dependency manager 79 may provide data associated with dependencies that are present on the mobile terminal and data associated with runtime errors to the data storage device 73.

It should be pointed out that in an alternative exemplary embodiment, the PEM device 64 may be implemented on electronic devices that are already in the marketplace i.e., on legacy devices. For example, the PEM device 64 may be an application specific integrated circuit (ASIC) that may be inserted in a slot of a device such as a mobile terminal. Alternatively, when the PEM device 64 is comprised of software, the PEM device 64 may be sent or deployed to one or more devices (e.g., mobile terminals) from a server such as origin server 54 or computing systems 52 and once received the controller 20 may install the PEM device 64 on devices of the wireless communication system of FIG. 2, for example. In this regard, the PEM device 64 facilitates modification of a current or existing system in such a way that the current or existing system is capable of adding libraries such as one or more mixed-language libraries to the respective platform (e.g., Java platform). Implementing the PEM device 64 in an existing or current device may consist of modifying a runtime initializer on the device so that it is capable of reading the paths for all installed extension libraries from a data storage element such as data storage device 73 and is capable of providing the paths to a virtual machine (e.g., Java virtual machine).

The parameters that the runtime initializer (e.g., runtime initializer 66 such as for example a Java runtime initializer) passes to a virtual machine (e.g., VM 70) includes but are not limited to: (1) parameters associated with a path to an application library (that is included inside the non-native application 53, such for example a MIDlet, together with the application meta-data), from which all the application classes (that are included inside the application library) are loaded by the VM; (2) parameters associated with a path to the system class libraries (e.g., non-native library 55 such as a Java library), from where all the platform classes are loaded by the VM; (3) parameters associated with a path to an extension library (also referred to as extension library 1), for example non-native extension library 57, from where one or more extension classes or corresponding code (also referred to as extension 1 classes) are loaded by the VM; and (4) parameters associated with a path to one or more other extension libraries (also referred to as extension library N, where N denotes a number of extension libraries) for example other instances of non-native extension library 57 from where extension classes (also referred to as extension N classes, where N denotes a number of extension classes) are loaded by the VM. In this regard, the VM 70 is able to find the classes for all extensions. The extension classes may only be loaded by the VM 70, if the application such as application 53 is able to use the extension (e.g., extension package 67). It should be pointed out that the reference to class and/or classes above may correspond to code, routines or the like stored in libraries that maybe used by a particular program and/or platform.

When the origin server 54 or computer systems 52 sends or deploys the PEM device 64 to a mobile terminal that is already in the marketplace (e.g., legacy device) or the PEM device 64 is inserted in a slot of the mobile terminal in the manner discussed above, an existing security manager on the mobile terminal may need to be modified. Specifically, this modification may be needed because an extension library (e.g., non-native extension library 57) may want to introduce sensitive methods to a corresponding application (e.g., a Java application) that requires security checks to be made. In this regard, instead of using a fixed policy file, the security manager on the mobile terminal 10 is capable of reading one or more additional policy files that may be installed together with an extension, such as extension package 67. Once the security manager reads the data in one or more of these additional policy files, the security manager may check whether the application has the appropriate rights to execute the corresponding method or service associated with the code in the manner discussed above.

With respect to installation of non-native applications such as for example Java applications, these non-native applications are typically dynamically installed to the corresponding non-native platform, for example a Java platform. For instance, the installation of non-native applications typically takes place by utilizing a non-native installer component that is separate from a native installer. A non-native application may be packaged to a different package format than native applications and the non-native installer handles the installation of the non-native application using mechanisms specific for the non-native platform. However, for conventional devices that do not use the PEM device 64, the Java platform itself is typically static and may not be extended. In a static Java platform all Java APIs available for dynamically installed applications are fixed and cannot change after the corresponding device has left the factory (i.e., place of manufacture) or the Java APIs are pre-stored in memory on a corresponding device. A static Java platform may be stored to device read-only memory that cannot be changed. In this regard, when a user downloads a Java application or executes a Java application, a processor may identify it and the Java application may be installed by using a Java installer (which may be invoked after identifying the file type of the downloaded file). In contrast, a native installer may support installing both native applications and libraries that may be programmed using C/C++, for example.

Utilization of the PEM device 64 on devices such as mobile terminal 10 allows installation of not only non-native applications such as Java applications, but also non-native platform libraries such as Java platform libraries (i.e., extensions). The extension package such as extension package 67 may be packaged inside a native installation package and a native installer, which may be a program which automates the process of installing an application, may install the extension package, the same way it installs any native library. The PEM manager 71 may then detect the non-native extension (e.g., Java extension) and installs it to the respective platform (e.g., Java platform). In an alternative exemplary embodiment, the PEM manager 71 is capable of copying meta-data associated with the extension (e.g., non-native extension library 57), including the path to the extension library to the data storage device 73 and there is no formal installation process.

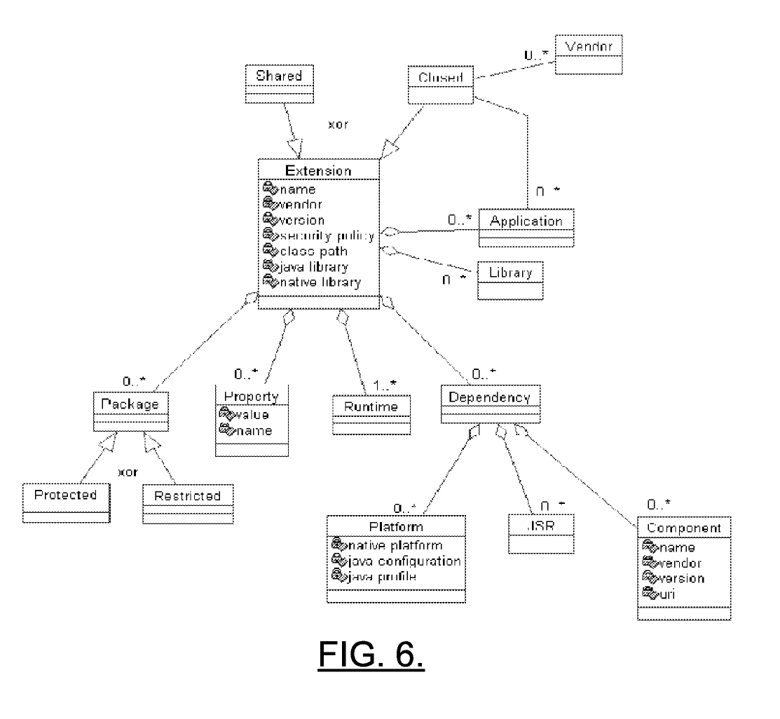

Referring to FIG. 6 a data model of an extension such as an extension of extension package 67 according to an exemplary embodiment is provided. It should be pointed out that the extensions of the exemplary embodiments of the present invention may include one or more descriptors that define extension characteristics. For example, descriptors of an extension such as PEMDescriptor.txt of PEM descriptor 88 shown in FIG. 7, and discussed more fully below may consist of extension characteristics that are in the form of the data model shown in FIG. 6. As shown in FIG. 6, an extension may have the following relating characteristics: (1) extension component name; (2) extension component vendor; (3) extension API properties; (4) extension component version; (5) extension component dependencies; (6) platform consisting of native platform, Java platform consisting of Java configuration, Java profile as well as optional Java platform APIs (JSRs) and other extensions or native components; (7) extension component classpath entries (e.g., JAR(s)); (8) extension component Java library name; (9) extension component native library name; (10) extension component protected and restricted packages; (11) extension component system properties; (12) extension component security policies; (13) information relating to whether the extension is a system extension that can override system Java classes; (14) runtimes for which this extension is available; (15) information relating to whether the extension is available only for particular application(s) or for all applications; and (16) the name of the application/library JAR that may be coupled with the extension.

Referring to FIG. 7, an illustration of an installation relating to an extension package according to an exemplary embodiment is provided. In FIG. 7, it should be pointed out that the components with dotted lines are optional components. The native installer 80 may be embodied in software consisting of a program which automates the installation of an extension package 84. It should be pointed out that the native installer may be an installer for a Symbian operating system or any other suitable operating system. In an alternative exemplary embodiment, the extension package 84 may be a Symbian Installation (SIS) package. As shown in FIG. 7, the native installer 80 is capable of verifying the integrity of the installation package and copying files to certain places in the system based on installation package meta-data which is different than extension meta-data that may be in a PEM descriptor. In an alternative exemplary embodiment, when the extension package 84 is a Symbian Installation (SIS) package, the integrity of the SIS file is verified by checking the hash values for all files in the SIS file. The hash values are stored into one or more SIS file meta-data parts, which are signed. Separate checksums for meta-data and the file data are present in the SIS file to enable corrupt SIS files to be detected by the native installer 80 at the beginning of the installation process. After the integrity of the native installation package is verified, the native installer is capable of copying the code IMEImidlet.jar of the non-native application 86 (e.g., MIDlet) to the PEM manager directory 100. In this regard, the native installer 80 is capable of copying an application 84 (e.g., a Java application such as a MIDlet) of the extension package 84 to a device for further installation by the non-native installer 102 (e.g. Java installer) which installs non-native applications if it is included in the extension package. Additionally, the native installer 80 is capable of copying code such as PEMDescriptor.txt of the PEM descriptor 88 to the PEM manager directory 100. Similarly, the native installer 80 is capable of installing code such as for example IMEIExtension.jar 92 of the non-native extension library 92 (e.g. Java extension library) to the extension directory 96. Furthermore, the native installer 80 may install code such as IMEIExtension.dll of the extension native library 94 to the device directory containing native binary files 98. All native executable and library files are available for execution from this directory without further configuration.

The PEM manager 82 (e.g., a Java Platform Extension Mechanism) may consist of software that prepares an application to run or execute in the mobile terminal 10. In an exemplary embodiment, the PEM manager 82 is capable of retrieving code such as IMEIMidlet.jar from the PEM manager directory 100 and installing the corresponding Java application associated with the code using the non-native installer 102 (e.g., Java installer which is invoked by the PEM manager 82). Additionally, the PEM manager 82 is capable of retrieving code such as PEMDescriptor.txt from the PEM manager directory 100 and reading the associated descriptor and registering the corresponding Java extensions.

As discussed above, the extension packages 67 and 84 may consist of Symbian installation (SIS) packages or files. The SIS packages or files may consist of certificates and/or signatures (e.g., digital signature) to identify the source of the extension packages and which may encrypt data associated with the extension packages. The native installer 80 may install the files from the SIS package in the manner discussed above. It should be pointed out that the native installer 80 does not have to be aware that it is installing an extension. Additionally, since the SIS package is signed with a signature or contains a certificate, the native installer 80 may evaluate the signature or certificate to identify and decrypt as well as authenticate the data associated with the corresponding extension package. In this regard, all the necessary security checks may be performed for the SIS package (which consists of the extension packages) by the native installer 80. The required steps to make the extension available to a non-native runtime (e.g., Java runtime) may be performed by the PEM device 64 which may be activated when the native installer 80 has completed the installation of the corresponding extension package. Since the extension packages may consist of SIS packages or files which have digital signatures or certificates that may be authenticated, the PEM system 60 can trust that the integrity and origin of the extensions have been checked by the native installer 80.

By utilizing SIS packages which may contain signatures or certificates, the native installer 80 may utilize an existing security model of the native operating system (Symbian OS) without having to completely define a new package verification and/or handling mechanism for extension packages containing mixed-language libraries. In this regard, the origin of one or more extension libraries can be trusted based on the certificate or signature.

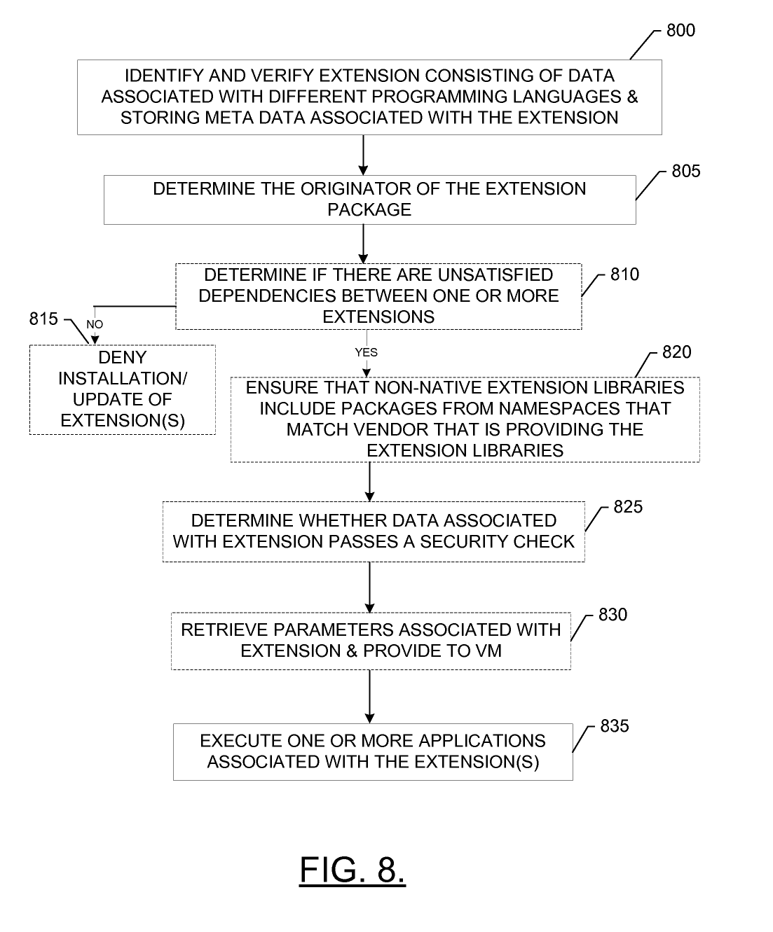

Referring to FIG. 8, a flowchart for providing secure-mixed language libraries to a device dynamically is provided. At operation 800, upon activation of an extension package containing one or more mixed-language libraries (such as a native library (e.g., C/C++ library containing C/C++ code) and a non-native library (e.g., Java library containing Java code), extensions are identified and verified. Activation may consist of installing, updating or uninstalling one or more extensions. Additionally, meta-data associated with the extension may be obtained from the extension and stored. The identification and verification of the extension as well as obtaining the meta-data of the extension may be performed by a device such as PEM manager 71 which provides the meta-data to data storage device 73. At operation 805, the computer instructions of the mixed-language libraries (e.g., non-native extension library 57 and native extension library 61) may be validated and an originator such as a vendor, for example, of the extension package may be validated when the extension package is installed to a platform. Optionally, at operation 810, unsatisfied dependencies between one or more extensions are determined. If no unsatisfied dependencies are found between one or more extensions, the installation, or update of one or more extensions proceeds. On the other hand, at operation 815, if the one or more unsatisfied dependencies between one or more extensions are not found, the installation or update of the corresponding extension(s) may be denied. In an alternative exemplary embodiment, a user may make a selection to complete the installation or update of the extension(s) even when the one or more unsatisfied dependencies are found. Optionally, at operation 820, a package manager ensures that non-native extension libraries include packages from namespaces that match the vendor that is providing the extension libraries.

Optionally, at operation 825 a determination is made as to whether data associated with the activated extension passes a security check. This security check may be determined by evaluating a profile and comparing an identifier in the profile with an identifier in the data associated with the extension. (Also a vendor of the extension package (e.g., SIS package) may be compared against a PEM list of allowed extension vendors. The PEM manager may perform the comparison of the vendor of the extension package against the PEM list.) When there is a match between the identifier in the profile and the identifier in data associated with the extension, a determination is made that the extension is secure. On the other hand, when the identifier in the profile and the identifier in the data associated with the extension does not match, a determination is made that the extension is not secure or at least is not from a secure source and in this regard, the installation or update of the extension may be denied. In an exemplary alternative embodiment, a selection may be made to continue update or installation of the extension even though the identifier in the profile and the identifier in the data associated with the extension did not match. Additionally, in an alternative exemplary embodiment, the extension may be packaged in an SIS package or file and a signature or certificate in the SIS package or file may be utilized to verify and/or authenticate the data associated with the extension in the manner discussed above.

Optionally, at operation 830, parameters (e.g., start-up parameters), generated during activation of the corresponding extension, are retrieved from data storage device such as data storage device 73 and parameters are provided to a virtual machine such as for example VM 70. It should be pointed out that activation of the corresponding extension may occur when a user of a device such as mobile terminal 10 activates a corresponding application icon. The parameters that are provided to the VM include but are not limited to: (1) parameters relating to a path to an application library (e.g., non-native libraries 55) from which all the application classes in the library may be loaded by the VM; (2) parameters relating to a path to system class libraries, (e.g., non-native library 55 such as a Java library) from where all the platform classes are loaded by the VM; (3) parameters relating to a path to an extension library (non-native extension library 57) from where extension classes are loaded by the VM; and/or (4) parameters relating to a path of N extension libraries from where n extension classes are loaded by the Java VM, where N and n denote numbers corresponding to a number of extension libraries and extension classes, respectively. At operation 835, an application (e.g., Java application such as a MIDlet for example) using the extension(s) may be executed. This application may optionally be installed together with the extension. In this regard, the application may or may not be installed together with the extension.

It should be understood that each block or step of the flowcharts, shown in FIG. 8 and combination of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium and executable by a processing element, such as the controller 20 of the mobile terminal 10.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing a platform comprising at least one package containing at least one first non-native application and one or more libraries, the one or more libraries contain computer instructions associated with a plurality of different programming languages, at least one of the libraries of the package comprises a native extension library;
utilizing the at least one first non-native application to call one or more of the computer instructions from at least one of the one or more libraries; and
executing the one or more computer instructions in the one or more libraries which adds one or more functions to the at least one first non-native application.

2. The method of claim 1, wherein utilizing comprises, the first non-native application calling at least one of the one or more computer instructions from a non-native extension library and the non-native extension library calling at least one of the one more computer instructions from the native extension library.

3. The method according to claim 1, further comprising:
utilizing a second non-native application to call at least one computer instruction from at least one non-native library among the libraries; and
executing the at least one computer instruction which adds one or more additional functions to the second non-native application.

4. The method of claim 1, wherein prior to executing the platform, sending the at least one package to an existing device.

5. The method of claim 1, further comprising utilizing an installer of a native operating system to install the functions.

6. The method of claim 1, wherein executing comprises receiving one or more parameters associated with a path to at least one of the one or more libraries and the method further comprises loading computer instructions of a native library, among the one or more libraries, into a non-native library, among the one or more libraries, the non-native library comprising computer instructions which adds functions to the first non-native application.

7. The method of claim 6, further comprising validating the computer instructions and an originator of the package when the package is installed to the platform.

8. The method of claim 6, wherein receiving one or more parameters comprises one or more of receiving parameters associated with a path to an application library that is included in the non-native application from which one or more application classes are loaded, parameters associated with a path to system class libraries from which one or more platform class libraries are loaded, or parameters associated with a path to an extension library, among the one or more libraries, from where one or more of the computer instructions which adds the functions are loaded.

9. The method of claim 6, further comprising validating the software code by evaluating an identifier to determine whether the first non-native application has a right to execute one or more functions specified by the computer instructions.

10. The method of claim 9, wherein validating the computer instructions comprises utilizing a native installer of a native operating system to validate the computer instructions.

11. The method of claim 9, wherein evaluating an identifier comprises determining whether a namespace associated with the computer instructions corresponds to a name of an originator of the computer instructions.

12. The method of claim 11, wherein when the determination reveals that the namespace does not correspond to the name of the originator prohibiting the installation of the computer instructions.

13. The method of claim 4, further comprising utilizing meta-data associated with the computer instructions to determine dependencies between software code of the non-native application, native library and the non-native library.

14. The method of claim 1, wherein the native extension library comprises one or more computer instructions for a non-native application and at least one of the instructions adds the functions when executed.

15. The method of claim 1, wherein the native extension library comprises at least one of the one or more computer instructions for a non-native application, the non-native application calls at least one of the computer instructions of the native extension library which is received via a non-native library and the at least one instruction adds at least one of the functions when executed.

16. An apparatus comprising a processing element configured to:
provide a platform comprising at least one package containing at least one first non-native application and one or more libraries, the one or more libraries contain computer instructions associated with a plurality of different programming languages, at least one of the libraries of the package comprises a native extension library;
utilize the at least one first non-native application to call one or more of the computer instructions from at least one of the one or more libraries; and
execute the one or more computer instructions in the one or more libraries which adds one or more functions to the at least one first non-native application.

17. The apparatus of claim 16, wherein utilize comprises, the first non-native application calling at least one of the one or more computer instructions from a non-native extension library and the non-native extension library calling at least one of the one more computer instructions from the native extension library.

18. The apparatus of claim 16, wherein the processing element is further configured to:
utilize a second non-native application to call at least one computer instruction from at least one non-native library among the libraries; and
execute the at least one computer instruction which adds one or more additional functions to the second non-native application.

19. The apparatus of claim 16, wherein the processing element is further configured to receive the at least one package.

20. The apparatus of claim 16, wherein the processing element is further configured to utilize an installer of a native operating system to install the functions.

21. The apparatus of claim 16, wherein the processing element is configured to execute the platform by receiving one or more parameters associated with a path to at least one of the one or more libraries, and wherein the processing element is further configured to load computer instructions of a native library, among the one or more libraries, into a non-native library, among the one or more libraries, the non-native library comprises computer instructions which adds functions to the first non-native application.

22. The apparatus of claim 21, wherein the processing element is further configured to validate the computer instructions and an originator of the package when the package is installed to the platform.

23. The apparatus of claim 16, wherein the native extension library comprises one or more computer instructions for a non-native application and at least one of the instructions adds the functions when executed by the processor.

24. The apparatus of claim 16, wherein the native extension library comprises at least one of the one or more computer instructions for a non-native application, and wherein the processor is configured to enable the non-native application to call at least one of the computer instructions of the native extension library which is received via a non-native library and the at least one instruction adds at least one of the functions when executed by the processor.

25. A computer program product comprising at least one computer-readable storage medium having computer-readable program code portions stored therein, the computer readable code portions comprising:
a first executable portion for providing a platform comprising at least one package containing at least one first non-native application and one or more libraries, the one or more libraries contain computer instructions associated with a plurality of different programming languages;
a second executable portion for utilizing the at least one first non-native application to call one or more of the computer instructions from at least one of the one or more libraries; and
a third executable portion for executing the one or more computer instructions in the one or more libraries which adds one or more functions to the at least one first non-native application.

26. The computer program product according to claim 25, further comprising:
a fourth executable portion for utilizing a second non-native application to call at least one computer instruction from at least one non-native library among the libraries; and
a fifth executable portion for executing the at least one computer instruction which adds one or more additional functions to the second non-native application.

27. The computer program product of claim 25, further comprising a fourth executable portion for sending the at least one package to an existing device.

28. The computer program product of claim 25, further comprising a fourth executable portion for utilizing an installer of a native operating system to install the functions.

29. The computer program product of claim 25, wherein the native extension library comprises at least one of the one or more computer instructions for a non-native application, the non-native application calls at least one of the computer instructions of the native extension library which is received via a non-native library and the at least one instruction adds at least one of the functions when executed.

30. An apparatus, comprising:
means for providing a platform comprising at least one package containing at least one first non-native application and one or more libraries, the one or more libraries contain computer instructions associated with a plurality of different programming languages, at least one of the libraries of the package comprises a native extension library;
means for utilizing the at least one first non-native application to call one or more of the computer instructions from at least one of the one or more libraries;
means for executing the one or more computer instructions in the one or more libraries which adds one or more functions to the at least one first non-native application.

31. The apparatus of claim 30, further comprising:
means for utilizing a second non-native application to call at least one computer instruction from at least one non-native library among the libraries; and
means for executing the at least one computer instruction which adds one or more additional functions to the second non-native application.

32. The apparatus of claim 30, further comprising means for receiving the at least one package.

33. The apparatus of claim 30, wherein the native extension library comprises one or more computer instructions for a non-native application and at least one of the instructions adds the functions when executed.

34. The apparatus of claim 33, wherein at least one other library of the libraries comprises a non-native extension library comprising one or more computer instructions for a non-native application, and at least another instruction of the instructions adds the functions when executed.

35. The apparatus of claim 30, wherein the native extension library comprises at least one of the one or more computer instructions for a non-native application, and wherein the means for executing is configured to enable the non-native application to call at least one of the computer instructions of the native extension library which is received via a non-native library and the at least one instruction adds at least one of the functions when executed.
